(19) United States
(12) Patent Application Publication
(10) Pub. No.: US 2008/0125523 A1
(43) Pub. Date: May 29, 2008

(54) Liquid Or Low Melting Stabilizer Formulation

(76) Inventors: Peter Staniek, Binzen (DE); Jan Malik, St Louis (FR)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/793,743

(22) PCT Filed: Dec. 21, 2005
(86) PCT No.: PCT/EP05/56998

§ 371 Date: Jun. 21, 2007

(30) Foreign Application Priority Data
Dec. 22, 2004 (EP) 04106905.5

(51) Int. Cl. C08K 5/49; C08K 5/3492; C09K 3/00

(52) U.S. Cl. 524/100; 524/121; 252/182.29

(57) ABSTRACT

The instant invention relates to liquid or low melting mixtures of phosphines with phenolic antioxidants as stabilizers for thermoplastic polymers.

It further relates to amorphous compositions of phosphines with phenolic antioxidants and their use for stabilization of thermoplastic polymers.

### TECHNICAL FIELD

The instant invention relates to liquid or low melting mixtures of phosphines with phenolic antioxidants as stabilizers for thermoplastic polymers.

It further relates to amorphous compositions of phosphines with phenolic antioxidants and their use for stabilization of thermoplastic polymers.

### TECHNICAL BACKGROUND

As known in the art the processing as well as the use of polymeric materials requires a stabilization package usually composed of primary antioxidants (sterically hindered phenols, AO) combined with secondary stabilizers (phosphorus based processing stabilizers, PS) to maintain the polymer properties. Such combinations of phenolic AO with PS like phosphites and phosphonites are known and used for long times. Also the use of phosphines as single component PS has recently been described, e.g. in WO-A-03/014213 or EP-A-1 462 478.

U.S. Pat. No. 5,362,783 discloses a polymer composition comprising a polycarbonate and an essentially epoxide-free stabilizer composition comprising

a) a phosphine of the general formula

PR¹R²R³ (1)

wherein R¹, R² and R³ independently from each other represent an alkyl, cycloalkyl, aryl or aryl-alkyl group or an aryl group which is substituted at the aromatic ring with one or more halogens and/or one or more alkyl or alkoxy groups and
b) a hindered phenol.

According to the disclosure of the description the compositions are blended at room temperature. The examples don't give any further details about the mixing process.

U.S. Pat. No. 6,369,140 discloses a polymeric composition containing 100.0 parts 3rd generation polypropylene homopolymer, 0.05 parts of tetrakis(methylene-3,(3′,5′-di-tert.butyl-4′-hydroxyphenyl)propionate) methane commercially available as Irganox 1010 (a trademark), 0.1 parts calcium stearate and 0.04 parts of tris(4-methyl-phenyl)phosphine. The composition disclosed in example 6 was mixed by dry blending.

Most of the polymer producers or converters use solid additives or additive formulations (blends) as mixtures of powders or converted into a specific form by extrusion, pelletizing, pressing and the like. In addition, the solidification of a melt on cooling bands to individual solidified droplets respectively strand which is broken in an additional processing step leads to solidified blends. Such formulations have the advantages for the user as lower storage capacities, less dosing equipment, constant ratio of the components of the blends as well reduced dust emissions in case of formed blends. The powder blends in contrast might show segregation effects which lead to inhomogeneities. These blends are preferably made from compounds having higher melting points, as low melting point products tend to block during manufacturing of such blends but also on storage. Especially products with melting point of less than about 60° C. are prone to such blocking effects, leading to large inconveniencies for the user.

An alternative possibility for dosing additives, especially for those being liquid at ambient temperature, is the direct dosing by pumping to the extruders. This offers advantages concerning precision and working hygiene as no dust emission can occur and the products are handled in close systems also avoiding contamination of the products by e.g. dust or other products.

As many of the additives of choice have high melting points of well above 100° C., the application as melt is economically not applicable and also technically difficult (e.g. freezing of tubes, pumps and tanks). Corresponding complex and expensive countermeasures like double wall piping and good isolation would be necessary. Therefore this kind of dosing is only applicable when the melting point of the additives or additive blends is below a certain value of approximately 80-100° C.

For dosing liquid or low melting additives, not many products are available, especially for phosphorus containing processing stabilizers (PS) of the phosphite or phosphonite type having a high performance level. The only low melting/liquid product having a reasonable market share is tris(nonylphenyl)phosphite (TNPP), but this product has drawbacks regarding hydrolytic stability. The degradation products of that process are known to cause yellowing or so called black specs formation during the processing of the polymers. In addition, taste and odor properties of the polymers are disturbed. Furthermore, this product is under discussion concerning certain ecological aspects.

Further additives necessary for the stabilization of polymers during processing and safeguarding the product properties over the lifetime are sterically hindered phenolic antioxidants (AO). Favorable for use in low melting systems is octadecyl (4-hydroxy,-3,5-di-tert.-butyl-phenyl)-hydrocinnamate, available e.g. under the trade name Hostanox® O 16 from Clariant with a melting point of about 48-54° C.

But combining two esters, in this case TNPP and Hostanox® O 16, might result at elevated temperature to a certain extend in transesterification reactions, which have to be avoided to maintain the product properties, including also melting points or solubilities. Therefore using these low melting products, separate dosing would be preferred, requiring two separate dosing equipments.

### DISCLOSURE OF INVENTION

Surprisingly it has now been found that mixtures of phosphines of the formulae (Ib) to (Id) with phenolic antioxidants of the formulae (IIa) to (IId) can overcome the problems of the state of the art mixtures of liquid phosphites (TNPP) and phenolic AO.

### DETAILED DESCRIPTION OF INVENTION

Therefore subject of the instant invention are mixtures comprising

### (A) one or more phosphine compounds of formulae (Ib) to (Id), preferably of formulae (Ib) and (Ic), more preferably of formula (Ib),

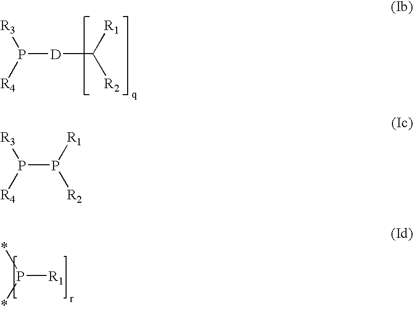 [0016] wherein
R₁ to R₄ independently of each other, are C₁₋₂₄alkyl (linear or branched, optionally containing in the chain N, O, P, S), C₅₋₃₀cycloalkyl (optionally containing in the ring N, O, P, S), C₁₋₃₀alkylaryl, C₆₋₂₄aryl, C₅₋₂₄heteroaryl, C₆₋₂₄aryl (substituted with C₁₋₁₈alkyl (linear or branched), C₅₋₁₂cycloalkyl or C₁₋₁₈alkoxy), C₅₋₂₄heteroaryl (substituted with C₁₋₁₈alkyl (linear or branched), C₅₋₁₂cycloalkyl or C₁₋₁₈alkoxy);
D is a (q+1)-valent residue consisting of C₁₋₃₀alkylen (linear or branched, optionally containing in the chain N, O, P, S), C₁₋₃₀alkyliden (linear or branched, optionally containing in the chain N, O, P, S), C₅₋₁₂cycloalkylen (linear or branched, optionally containing in the ring N, O, P, S), C₆₋₂₄arylen, C₆₋₂₄arylen (substituted by C₁₋₁₈alkyl (linear or branched), C₅₋₁₂cycloalkyl or C₁₋₁₈alkoxy), C₆₋₂₄heteroarylen (optionally substituted by C₁₋₁₈alkyl (linear or branched), C₅₋₁₂cycloalkyl or C₁₋₁₈alkoxy);
q is from 1 to 5;
r is from 3 to 6,
and wherein the groups P—R₁ in formula (Id) form a phosphacyclic compound, indicated by * at the bonds originating from P,
and wherein compounds of formula (Id) can for clarification also be described by formula (Id-d)

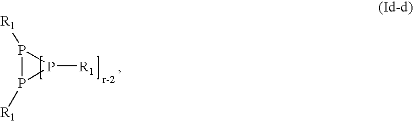

with formula (Id) and formula (Id-d) being equivalent,
   and

### (B) one or more phenolic antioxidant compounds of formula (IIa)

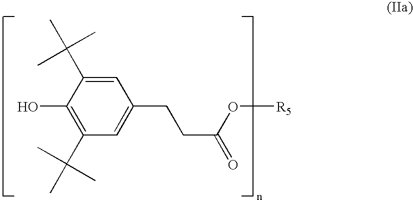 [0025] wherein
n is from 1 to 6
R₅ for n=1 is C₁₋₆₀alkyl, C₅₋₃₀cycloalkyl, C₁₋₃₀alkylaryl, C₆₋₂₄aryl, C₅₋₂₄heteroaryl, C₆₋₂₄aryl (substituted with C₁₋₈alkyl (linear or branched), C₅₋₁₂cycloalkyl or C₁₋₁₈alkoxy), C₅₋₂₄heteroaryl (substituted with C₁₋₁₈alkyl (linear or branched), C₅₋₁₂cycloalkyl or C₁₋₁₈alkoxy);
   for n>1 is C₁₋₂₄alkylene, C₁₋₂₄alkylene-S—C₁₋₂₄alkylene, C₅₋₃₀cycloalkylene, C₁₋₃₀alkylarylene, C₆₋₂₄arylene, C₅₋₂₄heteroarylene, C₁₋₂₄alkylidene;
or of formula (IIb)

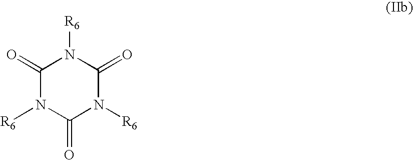

or of formula (IIc)

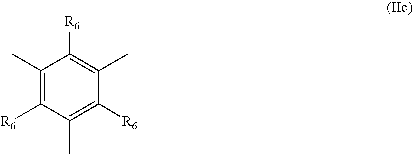

wherein
R₆ is selected from the residues

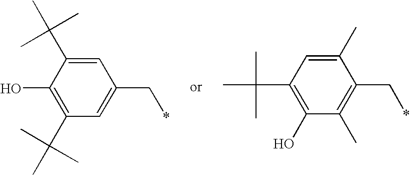

(* indicate the connection position to the residue)
or of formula (IId)

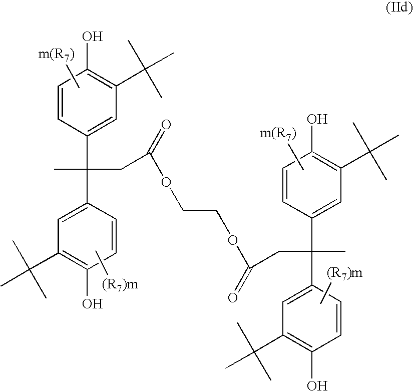

wherein
R₇ is hydrogen, C₁₋₂₄alkyl (linear or branched), C₁₋₂₄alkyloxy (linear or branched), and
m is from 0 to 3;
   preferably

### (B) one or more phenolic antioxidant compounds of formulae (IIa) and (IId), more preferably of formula (IIa).

Preferred are mixtures comprising

### (A) one or more phosphine compounds of formulae (Ib) to (Id), more preferred of formulae (Ib) and (Ic), even more preferred of formula (Ib), wherein

R₁ to R₄ independently of each other, are C₆₋₂₄alkyl (linear or branched), C₆₋₁₈cycloalkyl, C₇₋₂₅alkylaryl, C₆₋₁₈aryl, C₅₋₁₈heteroaryl, C₆₋₁₈aryl (substituted with C₁₋₁₂alkyl (linear or branched), C₆₋₈cycloalkyl or C₁₋₁₂alkoxy), C₅₋₁₈heteroaryl (substituted with C₁₋₁₂alkyl (linear or branched), C₆₋₈cycloalkyl or C₁₋₁₂alkoxy);
D is a (q+1)-valent residue consisting of C₁₋₂₄alkylen (linear or branched), C₁₋₂₄alkyliden (linear or branched), C₅₋₈cycloalkylen, C₆₋₁₈arylen, C₆₋₁₈heteroarylen, C₆₋₁₈arylen (substituted by C₁₋₁₈alkyl (linear or branched), C₆₋₈cycloalkyl or C₁₋₁₈alkoxy), C₆₋₁₈heteroarylen (optionally substituted by C₁₋₁₈alkyl (linear or branched), C₆₋₈cycloalkyl or C₁₋₁₈alkoxy);
   and

### (B) one or more phenolic antioxidant compounds of formulae (IIa) to (IId), more preferred of formula (IIa), wherein

n is from 1 to 4,
R₅ for n=1 is C₁₋₁₈alkyl, C₅₋₁₈cycloalkyl, C₁₋₂₄alkylaryl, C₆₋₁₈aryl, C₅₋₁₈heteroaryl, C₆₋₁₈aryl (substituted with C₁₋₁₂alkyl (linear or branched), C₆₋₈cycloalkyl or C₁₋₁₂alkoxy), C₅₋₁₈heteroaryl (substituted with C₁₋₁₂alkyl (linear or branched), C₆₋₈cycloalkyl or C₁₋₁₂alkoxy),
   for n>1 is C₁₋₁₈alkylene, C₁₋₁₈alkylene-S—C₁₋₁₈alkylene, C₆₋₈cycloalkylene, C₁₋₁₈alkylarylene, C₆₋₁₈arylene, C₅₋₁₈heteroarylene, C₁₋₁₈alkylidene;
R₆ is selected from the residues

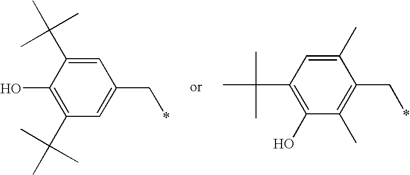

(* indicate the connection position to the residue)
R₇ is hydrogen, C₁₋₁₈alkyl (linear or branched), C₁₋₁₈alkyloxy (linear or branched), and
m 0 to 2.

More preferred are mixtures comprising

### (A) one or more phosphine compound of formulae (Ib) to (Id), more preferred of formulae (Ib) and (Ic), even more preferred of formula (Ib), wherein

R₁ to R₄ independently of each other, are C₆₋₁₈alkyl (linear or branched), C₆₋₁₂cycloalkyl, C₇₋₁₈alkylaryl, C₆₋₁₂aryl, C₅₋₁₂heteroaryl, C₆₋₁₂aryl (substituted with C₁₋₈alkyl (linear or branched), cyclohexyl or C₁₋₈alkoxy), C₅₋₁₂heteroaryl (substituted with C₁₋₈alkyl (linear or branched), cyclohexyl or C₁₋₈alkoxy);
D is a (q+1)-valent residue consisting of C₁₋₁₈alkylen, C₁₋₁₈alkyliden, C₅₋₆cycloalkylen, C₆₋₁₂arylen, C₆₋₁₂heteroarylen, C₆₋₁₂arylen (substituted by C₁₋₁₂alkyl or C₅₋₆cycloalkyl or C₁₋₁₂alkoxy), C₆₋₁₂heteroarylen (optionally substituted by C₁₋₁₂alkyl, C₅₋₆cycloalkyl or C₁₋₁₂alkoxy);
   and

### (B) one or more phenolic antioxidant compounds of formulae (IIa) to (IId), more preferred of formula (IIa), wherein

n is 1 to 4,
R₅ for n=1 is C₁₋₁₂alkyl, C₆₋₈cycloalkyl, C₁₋₁₂alkylaryl, C₆₋₁₂aryl, C₅₋₁₂heteroaryl, C₆₋₁₂aryl (substituted with C₁₋₈alkyl (linear or branched), cyclohexyl or C₁₋₈alkoxy), C₅₋₁₂heteroaryl (substituted with C₁₋₈alkyl (linear or branched), cyclohexyl or C₁₋₈alkoxy),
   for n>1 is C₁₋₁₂alkylene, C₁₋₁₂alkylene-S—C₁₋₁₂alkylene, cyclohexylene, C₁₋₁₂alkylarylene, C₆₋₁₂arylene, C₅₋₁₂heteroarylene, C₁₋₁₂alkylidene;
R₆ is selected from the residues

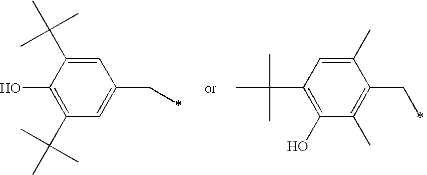

(* indicate the connection position to the residue)
R₇ is hydrogen, C₁₋₁₂alkyl (linear or branched), C₁₋₁₂alkyloxy (linear or branched), and
m is 0 or 1.

Especially preferred are mixtures comprising

### (A) one or more phosphine compounds of the following formulae (Ih) to (Ip)

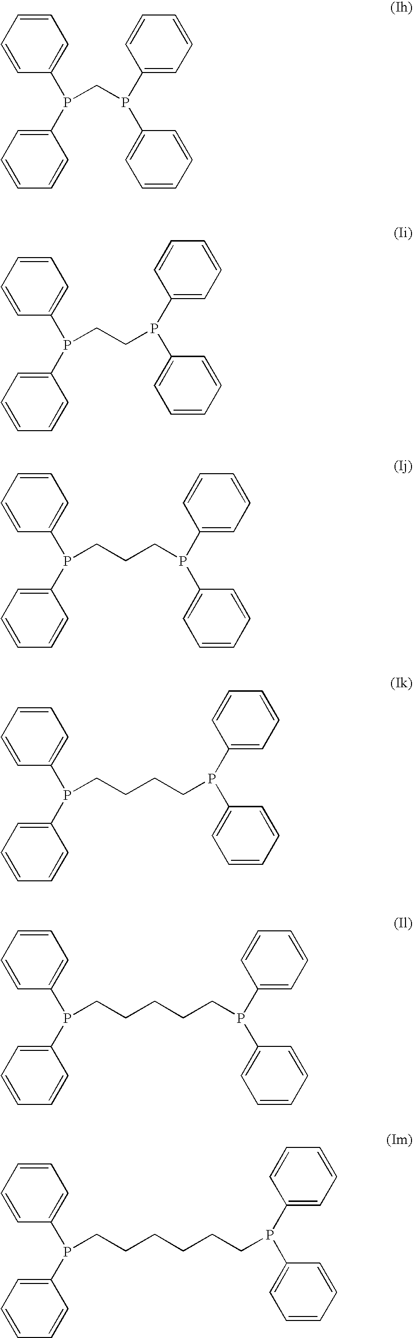

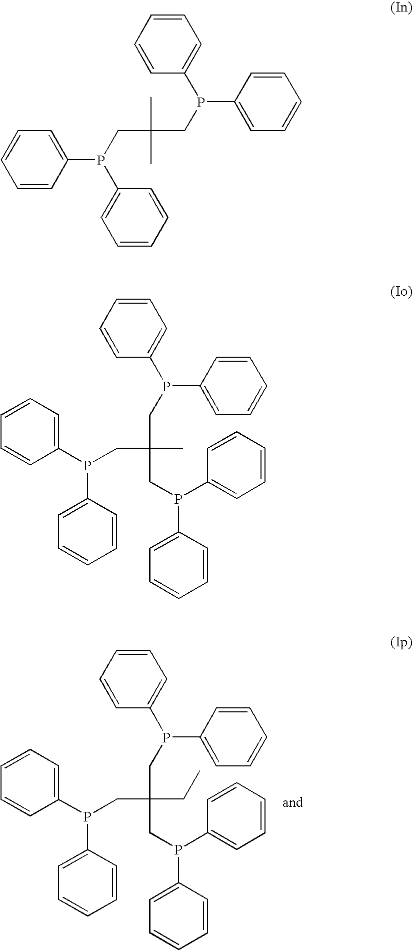

### (B) one or more phenolic antioxidant compounds of the following formulae (IIe) to (IIk)

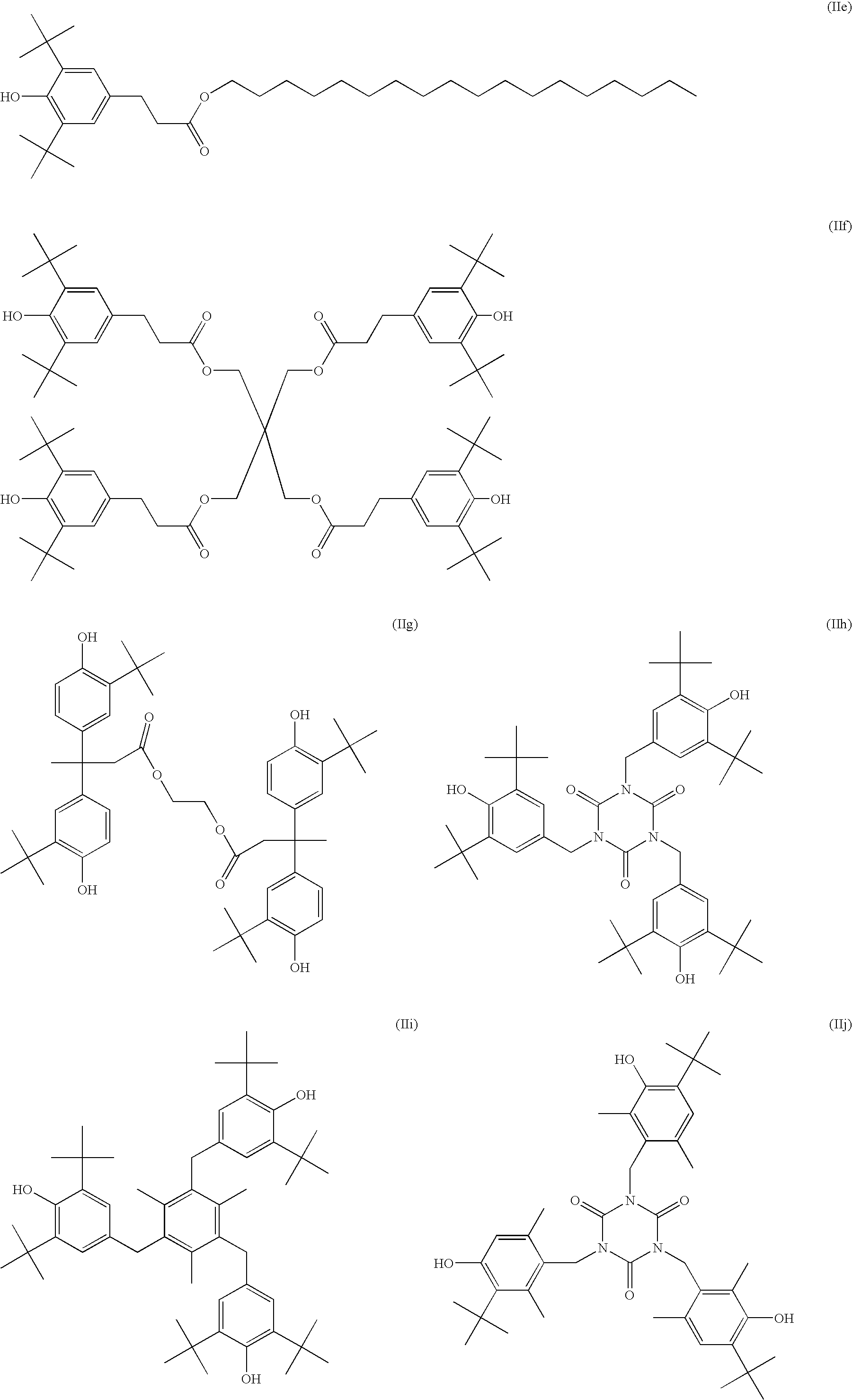

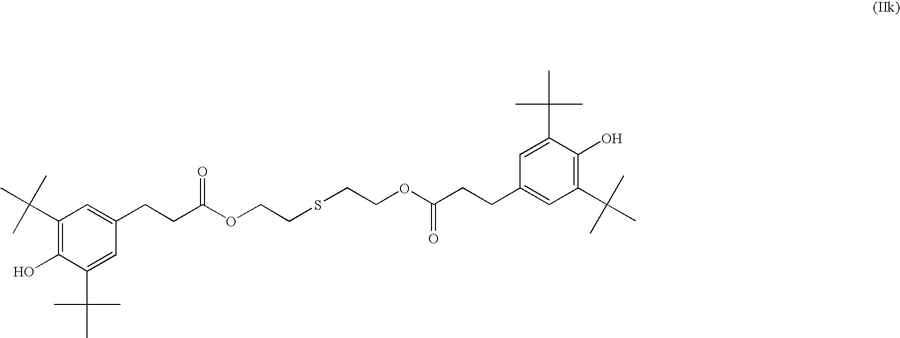

Very especially preferred are mixtures comprising

### (A) one or more phosphine compounds of the formula Ih, Ii, Ij, In, Io or Ip

and

### (B) one or more phenolic antioxidant compounds of the formula IIe, IIf, IIg, IIh IIi or IIj,

even more especially preferred are mixtures comprising

### (A) one or more phosphine compounds of the formula In, Io or Ip

and

### (B) one or more phenolic antioxidant compounds of the formula IIe or IIf, preferably of the formula IIe.

Further even more especially preferred is a mixture comprising 1,3-Bis(diphenylphosphino)-2,2-dimethyl-propane of formula (In) and octadecyl-(4-hydroxy-3,5-di-tert.-butyl-phenyl)-hydrocinnamate of formula (IIe);

further even more especially preferred is a mixture comprising 1,3-Bis(diphenylphosphino)-2,2-dimethyl-propane of formula (In) and tetrakis(methylene-3,(3′,5′-di-tert.butyl-4′-hydroxyphenyl)propionate) methane of formula (IIf);
further even more especially preferred is a mixture comprising 1,3-Bis(diphenylphosphino)-2,2-dimethyl-propane of formula (In) and bis[3,3-bis(4′-hydroxy-3′-tert-butyl-phenyl)butandioic acid]glycol ester of formula (IIg).

In the inventive mixtures comprising at least one component (A) and at least one component (B), the components (A) and/or (B) can be in an amorphous or in a crystalline state, or the inventive mixtures can be a mixture of amorphous and/or crystalline material of the components (A) and (B), wherein component (A) and component (B) are as defined above with all described preferred aspects of component (A) and component (B).

The amorphous state of a solid is characterized by a non regular organization of the molecules, so that no regular lattice structure is formed. A well known example of that state is glass. According to that the amorphous state is also frequently called glassy state.

The amorphous state can be determined X-ray powder diffraction. The powder pattern of a amorphous substance will no longer show the characteristic lines of the crystalline substance. A further method to characterize the amorphous state of a substance is the measurement of the thermal properties, preferably differential scanning calorimetry (DSC) measurement. In case of a crystalline substance normally an endothermal melting peak is observe during the heating. The integral of this peak corresponds to the lattice energy which is necessary to break up the crystal lattice during the melting process. In contrast to that, an amorphous substance will not show such a thermal effect as there is no lattice energy to overcome during the melting.

Therefore in practical applications it is advantageous to use amorphous instead of crystalline substances when a melting step is involved in the process, as the required energy consumption of the process is lowered.

Also when dosing a substance as a melt to the process, it is advantageous to use an amorphous substance, as the required energy for melting the substance is lower compared to a crystalline substance.

Preferably the inventive mixtures comprising at least one component (A) and at least one component (B) contain at least 25% by weight, more preferably at least 50% by weight, even more preferably at least more than 75% by weight, especially preferably at least 90% by weight, and more especially preferably at least 95% by weight, based on the weight of the total mixture, of an amorphous mixture of the components (A) and (B);

with components (A) and (B) represented also in all their preferred aspects as mentioned above.

The remaining part of the inventive mixtures comprising at least one component (A) and at least one component (B) can be crystalline components (A) and/or (B); in this case, where no further substances are present, the amorphous and the crystalline material of components (A) and (B) add up to 100% by weight of the composition. Of course the inventive mixtures can also consist of an amorphous mixture of at least one component (A) and at least one component (B) only.

The percentage of amorphous material is calculated by the ratio of the observed melting energy of the inventive mixtures measured by DSC in relation to the melting energy of the individual crystalline components from which the mixtures has been prepared, taking into account the weight ratios of the components in the mixture.

In case of amorphous mixtures of components (A) and (B), component (A) is preferably of formula (In).

The invention relates further to amorphous compositions comprising one or more components (C) and one or more components (B),

wherein the component (C) is a phosphine compound of formula (Ia)

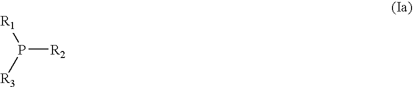

wherein
R₁ to R₃ independently of each other, are C₁₋₂₄alkyl (linear or branched, optionally containing in the chain N, O, P, S), C₅₋₃₀cycloalkyl (optionally containing in the ring N, O, P, S), C₁₋₃₀alkylaryl, C₆₋₂₄aryl, C₅₋₂₄heteroaryl, C₆₋₂₄aryl (substituted with C₁₋₁₈alkyl (linear or branched), C₅₋₁₂cycloalkyl or C₁₋₁₈alkoxy), C₅₋₂₄heteroaryl (substituted with C₁₋₁₈alkyl (linear or branched), C₅₋₁₂cycloalkyl or C₁₋₁₈alkoxy);
   and wherein the component (B) is a phenolic antioxidant compound of formula (IIa)

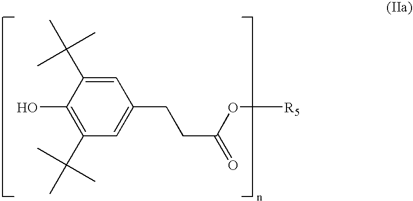

wherein
n is from 1 to 6;
R₅ for n=1 is C₁₋₆₀alkyl, C₅₋₃₀cycloalkyl, C₁₋₃₀alkylaryl, C₆₋₂₄aryl, C₅₋₂₄heteroaryl, C₆₋₂₄aryl (substituted with C₁₋₁₈alkyl (linear or branched), C₅₋₁₂cycloalkyl or C₁₋₁₈alkoxy), C₅₋₂₄heteroaryl (substituted with C₁₋₁₈alkyl (linear or branched), C₅₋₁₂cycloalkyl or C₁₋₁₈alkoxy);
   for n>1 is C₁₋₂₄alkylene, C₁₋₂₄alkylene-S—C₁₋₂₄alkylene, C₅₋₃₀cycloalkylene, C₁₋₃₀alkylarylene, C₆₋₂₄arylene, C₅₋₂₄heteroarylene, C₁₋₂₄alkylidene;
      or of formula (IIb)

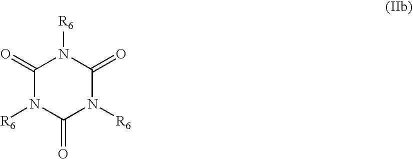

or of formula (IIc),

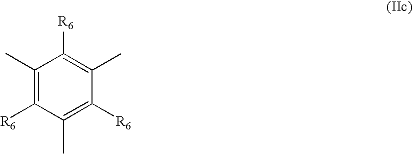

wherein
R₆ is selected from the residues

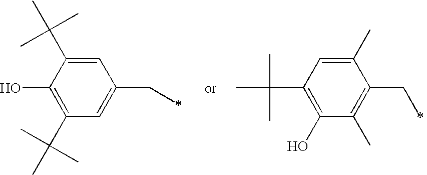

wherein * indicate the connection position to the residue,
   or of formula (IId),

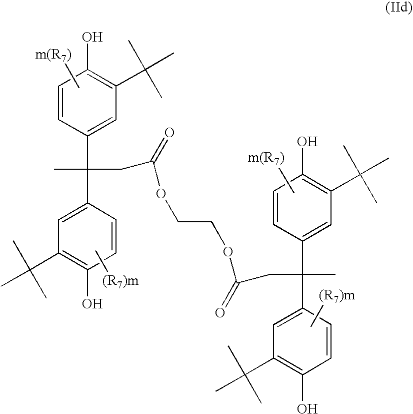

wherein
R₇ is hydrogen, C₁₋₂₄alkyl (linear or branched), C₁₋₂₄alkyloxy (linear or branched), and
m is from 0 to 3;
   preferably the component (B) is a compound of formula (IIa) or (IId), more preferably of formula (IIa).

Preferred are amorphous compositions comprising one or more components (C) and one or more components (B),

wherein the component (C) is a compound of formula (Ia)
wherein
R₁ to R₃ independently of each other, are C₆₋₂₄alkyl (linear or branched), C₆₋₁₈cycloalkyl, C₇₋₂₅alkylaryl, C₆₋₁₈aryl, C₅₋₁₈heteroaryl, C₆₋₁₈aryl (substituted with C₁₋₁₂alkyl (linear or branched), C₆₋₈cycloalkyl or C₁₋₁₂alkoxy), C₅₋₁₈heteroaryl (substituted with C₁₋₁₂alkyl (linear or branched), C₆₋₈cycloalkyl or C₁₋₁₂alkoxy);
   and wherein the component (B) is a compound of formulae (IIa) to (IId), more preferred of formula (IIa), wherein
n is from 1 to 4,
R₅ for n=1 is C₁₋₁₈alkyl, C₅₋₁₈cycloalkyl, C₁₋₂₄alkylaryl, C₆₋₁₈aryl, C₅₋₁₈heteroaryl, C₆₋₁₈aryl (substituted with C₁₋₁₂alkyl (linear or branched), C₆₋₈cycloalkyl or C₁₋₁₂alkoxy), C₅₋₁₈heteroaryl (substituted with C₁₋₂alkyl (linear or branched), C₆₋₈cycloalkyl or C₁₋₁₂alkoxy),
   for n>1 is C₁₋₁₈alkylene, C₁₋₁₈alkylene-S—C₁₋₁₈alkylene, C₆₋₈cycloalkylene, C₁₋₁₈alkylarylene, C₆₋₈arylene, C₅₋₁₈heteroarylene, C₁₋₁₈alkylidene;
R₆ is selected from the residues

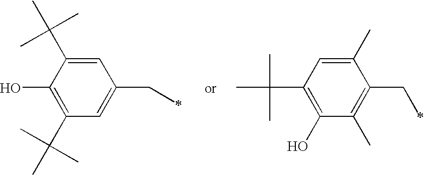

wherein * indicate the connection position to the residue,
R₇ is hydrogen, C₁₋₁₈alkyl (linear or branched), C₁₋₁₈alkyloxy (linear or branched), and
m 0 to 2.

More preferred are amorphous compositions comprising one or more components (C) and one or more components (B),

wherein the component (C) is a compound of formula (Ia),
wherein
R₁ to R₃ independently of each other, are C₆₋₁₈alkyl (linear or branched), C₆₋₁₂cycloalkyl, C₇₋₁₈alkylaryl, C₆₋₁₂aryl, C₅₋₁₂heteroaryl, C₆₋₁₂aryl (substituted with C₁₋₈alkyl (linear or branched), cyclohexyl or C₁₋₈alkoxy), C₅₋₁₂heteroaryl (substituted with C₁₋₈alkyl (linear or branched), cyclohexyl or C₁₋₈alkoxy);
   and wherein the component (B) is a compound of formulae (IIa) to (IId), more preferred of formula (IIa),
   wherein
n is 1 to 4,
R₅ for n=1 is C₁₋₁₂alkyl, C₆₋₈cycloalkyl, C₁₋₁₂alkylaryl, C₆₋₁₂aryl, C₅₋₁₂heteroaryl, C₆₋₁₂aryl (substituted with C₁₋₈alkyl (linear or branched), cyclohexyl or C₁₋₈alkoxy), C₅₋₁₂heteroaryl (substituted with C₁₋₈alkyl (linear or branched), cyclohexyl or C₁₋₈alkoxy),
   for n>1 is C₁₋₁₂alkylene, C₁₋₁₂alkylene-S—C₁₋₁₂alkylene, cyclohexylene, C₁₋₁₂alkylarylene, C₆₋₁₂arylene, C₅₋₁₂heteroarylene, C₁₋₁₂alkylidene;
R₆ is selected from the residues

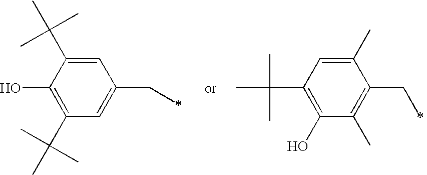

wherein * indicate the connection position to the residue,
R₇ is hydrogen, C₁₋₁₂alkyl (linear or branched), C₁₋₁₂alkyloxy (linear or branched), and
m is 0 or 1.

Especially preferred are amorphous compositions comprising one or more components (C) and one or more components (B),

wherein the component (C) is a compound of formulae (Ie) to (Ig)

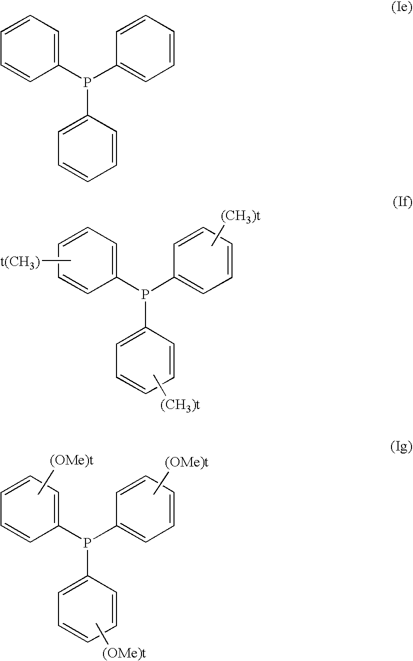

where t is 1 to 5, preferably t is from 1 to 3 and more preferably t is 1 or 2, even more preferably t is 1;
   and wherein the component (B) is a compound of formulae (IIe) to (IIk).

Very especially preferred are amorphous compositions comprising one or more components (C) and one or more components (B),
wherein the component (C) is a compound of formulae Ie to Ig, preferably Ie or If, with t being 1 or 2, preferably 1, more preferably with the methyl groups in ortho- or para-position, even more preferably in the para-position, to the phosphorus atom;
   and wherein the component (B) is a compound of formulae IIe, IIf, IIg, IIh, IIi or IIj;
   even more especially preferred are amorphous compositions comprising one or more components (C) and one or more components (B),
wherein the component (C) is a compound of formulae Ie, If or Ig, preferably Ie of If, with t being 1 or 2, preferably 1, more preferably with the methyl groups in ortho or para-position, even more preferably in the para-position, to the phosphorus atom;
   and wherein the component (B) is a compound of formulae IIe or IIf, preferably of the formula IIe;
   further even more especially preferred is an amorphous composition comprising tetrakis(methylene-3,(3′,5′-di-tert.butyl-4′-hydroxyphenyl)propionate) methane of formula (IIf) and tris(4-methyl-phenyl)phosphine of formula (If) with t being 1;
   further even more especially preferred is an amorphous composition comprising triphenylphosphine of formula (Ie) and octadecyl-(4-hydroxy-3,5-di-tert.-butyl-phenyl)hydrocinnamate of formula (IIe);
   further even more especially preferred is an amorphous composition comprising triphenylphosphine of formula (Ie) and tetrakis(methylene-3,(3′,5′-di-tert.butyl-4′-hydroxyphenyl)propionate) methane of formula (IIf);
   further even more especially preferred is an amorphous composition comprising triphenylphosphine of formula (Ie) and bis[3,3-bis(4′-hydroxy-3′-tert-butyl-phenyl)butandioic acid]glycol ester of formula (IIg).

The components (A), (B) and (C) are known substances.

In the following, the description “mixtures or compositions comprising component (A) or (C) and component (B)” means mixtures of component (A) with (B), these mixtures can optionally contain a component (C), preferably they contain no component (C), and it means mixtures of component (C) with (B), these mixtures can optionally contain a component (A), preferably they contain no component (A); and further with components (A), (B) and (C) represented also in all their preferred aspects as mentioned above.

The inventive amorphous compositions comprising one or more components (C) and one or more components (B) are produced by cooling a liquid mixture comprising one or more components (C) and one or more components (B) below the solidification point.

The liquid mixture comprising one or more components (C) and one or more components (B) is preferably prepared in a batch mixer or reactor or in continuous mixers or reactors.

The cooling is done preferably by prilling, dropping onto a cooled surface, preferably onto a cooled conveyor belt, extrusion to a strand, granulation under water, fluidized bed granulation, tumbling, flaking or spraying (including spraying from solutions/emulsions in supercritical gases).

The liquid mixture comprising one or more components (C) and one or more components (B) is preferably prepared by mixing the separately molten or liquid components (C) and (B) together, or by melting a mixture of the components (C) and (B); more preferably it is done by melting a mixture of the components (C) and (B). Further the liquid mixture comprising one or more components (C) and one or more components (B) is preferably prepared by adding a molten or liquid component (C), respectively (B), to a liquid or already molten component (B), respectively (C), or to a liquid or molten mixture comprising components (C) and (B), to obtain a liquid mixture of components (C) and (B).

Preferably the inventive mixtures comprising at least one component (C) and at least one component (B) contain at least 25% by weight, more preferably at least 50% by weight, even more preferably at least more than 75% by weight, especially preferably at least 90% by weight, and more especially preferably at least 95% by weight, based on the weight of the total mixture, of an amorphous mixture of the components (C) and (B).

The remaining part of the inventive mixtures comprising at least one component (C) and at least one component (B) can be crystalline components (C) and/or,(B); in this case, where no further substances are present, the amorphous and the crystalline material of components (C) and (B) add up to 100% by weight of the composition. Of course the inventive mixtures can also consist of an amorphous mixture of at least one component (C) and at least one component (B) only.

The percentage of amorphous material is calculated by the ratio of the observed melting energy of the inventive mixtures measured by DSC in relation to the melting energy of the individual crystalline components from which the mixtures has been prepared, taking into account the weight ratios of the components in the mixture.

The inventive amorphous mixtures and compositions comprising component (C) or (A) and component (B) may also contain other substances, preferably additives, which are necessary to maintain, improve or change the properties of the polymer. Preferably the inventive amorphous compositions contain less than 50% by weight, more preferably less than 25% by weight, even more preferably less than 10% by weight, particularly less than 5% by weight of other substances, based on the total weight of the composition; especially preferably the inventive amorphous mixtures and compositions comprising component (C) or (A) and component (B) contain no other substances.

These inventive mixtures comprising at least one component (A) and at least one component (B) and the inventive amorphous compositions comprising at least one component (C) and at least one component (B) contain highly efficient phosphines as processing stabilizers, offering the advantages of low dosing as well an inherent stability to hydrolysis as no ester groups are present in this kind of products. This excludes the chemical interaction like transesterification or hydrolysis.

In the case that the inventive mixtures consist of component (A) and component (B), they preferably contain from 1 to 99% by weight of the phosphine component (A) and from 99 to 1% by weight of the phenolic antioxidants (B), more preferably from 1 to 70% by weight of the phosphine component (A) and from 99 to 30% by weight of the antioxidants (B), even more preferably from 1 to 50% by weight of the phosphine component (A) and from 99 to 50% by weight of the antioxidants (B), especially from 1 to 40% by weight of the phosphine component (A) and from 99 to 60% by weight of the antioxidants (B), based on the total weight of the mixture, and the amounts of component (A) and (B) add up to 100% by weight of the mixture.

In the inventive amorphous compositions comprising at least one component (C) and at least one component (B), the relative weight ratio between component (C) and component (B) is preferably of from between 1 to 99 parts by weight of the component (C) and 99 to 1 parts by weight of the component (B), more preferably of from between 1 to 70 parts by weight of the component (C) and 99 to 30 parts by weight of the component (B), even more preferably of from between 1 to 50 parts by weight of the component (C) and 99 to 50 parts by weight of the component (B), especially of from between 1 to 40 parts by weight of the component (C) and 99 to 60 parts by weight of the component (B).

The instant mixtures may easily be prepared by mixing compounds (A) and (B) into a homogenous blend, heating that blend above the melting temperature of the higher melting compound, resp. the molten individual compounds (A) and (B) are mixed in the molten state, and forming small particles by e.g. grinding, compacting, pelletizing, prilling that blend while or after cooling down to a solid.

Further the mixtures of component (A) and component (B) can be prepared by conventional mixing of component (A) with component (B), with component (A) and component (B) preferably being in solid state for the conventional mixing.

The phosphines or the antioxidants can be applied as molten single compounds (two dosing lines) which are mixed online in the molten state, but also preferably as inventive mixtures consisting of one or more compounds of the individual product groups which can be fed by a single dosing line.

Preferably the inventive mixtures or compositions comprising component (A) or (C) and component (B), more preferably the inventive mixtures or compositions containing at least 25% by weight, based on the weight of the total mixture or composition, of an amorphous mixture of component (A) or (C) and component (B), are used in solid, liquid or molten state; by feeding the compositions by a single dosing line; especially the inventive mixtures or compositions comprising component (A) or (C) and component (B), more preferably the inventive mixtures or compositions containing at least 25% by weight, based on the weight of the total mixture or composition, of an amorphous mixture of component (A) or (C) and component (B), are used in liquid or molten state by feeding the compositions by a single dosing line.

The inventive mixtures can also be prepared from solutions of (A) or (C) and (B) in nonreactive solvents by precipitation or evaporation of the solvent to receive either a homogeneous melt or a solid.

The inventive mixtures comprising one or more components (A) and one or more components (B) are further produced by cooling a liquid mixture comprising one or more components (A) and one or more components (B) below the solidification point. The liquid mixture comprising one or more components (A) and one or more components (B) is preferably prepared in a batch mixer or reactor or in continuous mixers or reactors.

The cooling is done preferably by prilling, dropping onto a cooled surface (more preferably onto a cooled conveyor belt), extrusion to a strand, granulation under water, fluidized bed granulation, tumbling, flaking or spraying (including spraying from solutions/emulsions in supercritical gases).

The liquid mixture comprising one or more components (A) and one or more components (B) is preferably prepared by mixing the separately molten or liquid components (A) and (B) together, or by melting a mixture of the components (A) and (B); more preferably it is done by melting a mixture of the components (A) and (B).

Further the liquid mixture comprising one or more components (A) and one or more components (B) is preferably prepared by adding a liquid component (A), respectively (B), to a liquid or already molten component (B), respectively (A), or to a liquid or molten mixture comprising components (A) and (B), to obtain a liquid mixture of components (A) and (B).

The inventive blends and compositions comprising component (A) or (C) and component (B) provide melting points preferably below 120° C., more preferably below 100° C., even more preferably below 80° C. yielding low viscosity, homogeneous melts that can be easily dosed by conventional equipment and especially that equipment used in current liquid dosing processes. The low melting point may allow feeding without double wall heating and intensive insulation and even in case of freezing due to longer interruptions of the production, the mixture can easily be made liquid by gentle warming (e.g. trace heating). In practice, a simple to install trace heating is preferred. Therefore a further subject of the invention is the use of the inventive mixtures and compositions for stabilizing polymers, wherein the mixtures and compositions are added in liquid form preferably with a temperature below 120° C., more preferably below 100° C., even more preferably below 80° C., to the polymer, preferably the addition is done by liquid dosing.

In addition of being low melting, surprisingly the inventive blends and compositions comprising component (A) or (C) and component (B) solidify when cooling from a liquid state frequently in an amorphous, glassy state during cooling. This effect gives the advantage of lower energy consumption for re-liquefying compared to a crystalline material, as the significant energy input for breaking up the crystal lattice is not necessary.

This effect is observed especially in mixtures containing from 1 to 70% by weight of the phosphine component (A) or (C) and from 99 to 30% by weight of the phenolic antioxidants (B), based on the weight of the total mixtures; this effect is more pronounced in mixtures containing from 1 to 50% by weight of the phosphine compounds (A) or (C) and from 99 to 50% by weight of the phenolic antioxidants (B); the best effect is observed in mixtures containing from 1 to 40% by weight of the phosphine compounds (A) or (C) and from 99 to 60% by weight of the phenolic antioxidants (B), based on the total weight of the mixture.

The inventive mixtures and compositions comprising component (A) or (C) and component (B) are generally applicable as stabilizers in polymeric substrates, but preferably in polymers of olefins (ethylene, propylene, butane, hexane, octane, styrene and the like and copolymers thereof) summarized as polyolefins resp. polystyrenes. They are also suited to stabilize more polar so called engineering plastics, such as polyesters (e.g. polyethylene terephthalate (PET), polybutylene terephthalate (PBT)) or polyamides (e.g. polyamide 6, polyamide 6.6, polyamide 11, polyamide 12). Therefore a further subject of the invention is the use of the inventive mixtures and compositions for stabilizing polymers.

A further subject of the invention is the use of a composition comprising one or more components (A) or (C) and one or more components (B) for stabilizing polycarbonate characterized in that the composition comprising one or more components (A) or (C) and one or more components (B) contains at least 25% by weight, based on the weight of the total composition, of an amorphous mixture of components (A) or (C) and (B).

A further subject of the invention is the use of a composition comprising tris(4-methyl-phenyl)phosphine and tetrakis(methylene-3,(3′,5′-di-tert.butyl-4′-hydroxyphenyl)propionate) methane for stabilizing polyolefin characterized in that the composition comprising tris(4-methyl-phenyl)phosphine and tetrakis(methylene-3,(3′,5′-di-tert.butyl-4′-hydroxyphenyl)propionate) methane contains at least 25% by weight, based on the weight of the total composition, of an amorphous mixture of tris(4-methyl-phenyl)phosphine and tetrakis(methylene-3,(3′,5′-di-tert.butyl-4′-hydroxyphenyl)propionate) methane.

A further subject of the invention is the use of a composition comprising one or more components (A) and one or more components (B) for stabilizing polymeric substrates,
preferably polymers of olefins (ethylene, propylene, butane, hexane, octane, styrene and the like and copolymers thereof) summarized as polyolefins resp. polystyrene; more polar so called engineering plastics, preferably polyolefins, polystyrenes, polyesters, polyamides;
more preferably polyolefins and polystyrenes, even more preferably polyolefins;
further more preferably polyesters and polyamides, even more preferably polyesters;
especially polyethylene terephthalate (PET), polybutylene terephthalate (PBT), polyamide 6, polyamide 6.6, polyamide 11 and polyamide 12;
more especially polyethylene terephthalate (PET) and polybutylene terephthalate (PBT);
   characterized in that the composition comprising one or more components (A) and one or more components (B) contains at least 25% by weight, based on the weight of the total composition, of an amorphous mixture of components (A) and (B).

The inventive compositions and mixtures comprising components (A) or (C) and component (B) may also be used in other plastic materials known in the art, for example as described in WO 03/014213 A1 from page 12 to page 17.

Also other additives may be present in the polymers, depending on the needs during processing or exposure during use of the polymeric article, such as described for example in EP 1 462 478 A1 in paragraph [0013].

### EXAMPLES

In the disclosure “wt %” is equivalent to “% by weight”.

mp means melting point

### Example 1

Blends of 1,3-Bis(diphenylphosphino)-2,2-dimethyl-propan (P1) and octadecyl (4-hydroxy-3,5-di-tert. butyl-phenyl)hydrocinnamate (Hostanox® O 16 or just O 16) are prepared in the weight ratio given in the table below by heating to slightly above the melting temperature with stirring. The colorless and transparent melts are poured out into an aluminum dish and grinded after solidification. The melting points have been determined in a Büchi melting point apparatus.

| | | | | Visual Aspect |
|---|---|---|---|---|
| P1 | O 16 | mp. Start | mp End | of solidified |
| [wt %] | [wt %] | [° C.] | [° C.] | product |
| 0% | 100% | 51.4 | 53.5 | crystalline |
| 10% | 90% | 49.7 | 51.8 | amorphous |
| 20% | 80% | 49.8 | 67.4 | amorphous |
| 30% | 70% | 50.1 | 76.5 | amorphous |
| 40% | 60% | 49.7 | 79.8 | amorphous |
| 50% | 50% | 49.8 | 81.5 | amorphous |
| 60% | 40% | 50.0 | 83.5 | amorphous |
| 70% | 30% | 49.8 | 86.8 | amorphous |
| 80% | 20% | 68.8 | 87.7 | amorphous |
| 90% | 10% | 84.5 | 89.2 | crystalline |
| 100% | 0% | 90.0 | 90.5 | crystalline |

It clearly can be seen that the melting end temperature is always below the higher melting component and especially at <50 wt. % of P1 even below 80° C., allowing easily a liquid dosing of the melt.

### Example 2

Blends of 1,3-Bis(diphenylphosphino)-2,2-dimethyl-propan (P1) and tetrakis[methylene((4-hydroxy-3,5-di-tert. butyl-phenyl)hydrocinnamate)]methane (Hostanox® O 10 or just O 10) are prepared in the weight ratios given in the table below by heating to slightly above the melting temperature with stirring. The colorless and transparent melts are poured out into an aluminum dish and grinded after solidification. The melting points have been determined in a Büchi melting point apparatus.

| | | | | Visual Aspect |
|---|---|---|---|---|
| P1 | O 10 | mp. Start | mp End | of solidified |
| [wt %] | [wt %] | [° C.] | [° C.] | product |
| 0% | 100% | 64.9 | 84.9 | amorphous |
| 10% | 90% | 57.8 | 65.5 | amorphous |
| 20% | 80% | 51.2 | 55.8 | amorphous |
| 30% | 70% | 43.2 | 48.3 | amorphous |
| 40% | 60% | 37.5 | 80.1 | amorphous |
| 50% | 50% | * | * | Amorphous, |
| | | | | softening |
| 60% | 40% | * | * | Amorphous, |
| | | | | softening |
| 70% | 30% | 82.2 | 87.3 | amorphous |
| 80% | 20% | 86.4 | 88.3 | amorphous |
| 90% | 10% | 86.7 | 90.7 | crystalline |
| 100% | 0% | 90 | 90.8 | crystalline |

* melting points could not determined due to the soft and sticky behavior, mp should be close to room temperature

It clearly can be seen that the melting end temperature of the mixtures is always below the higher melting component and especially at <40 wt. % of P1 even below 80° C., allowing easily a liquid dosing of the melt.

### Example 3

Blends of 1,3-Bis(diphenylphosphino)-2,2-dimethyl-propan (P1) and bis[3,3-bis-(4′-hydroxy-3′-tert-butylphenyl)butanoic acid]glycol ester (Hostanox® O 3 or just O 3) are prepared in the weight ratios given in the table below by heating to slightly above the melting temperature with stirring. The colorless and transparent melts are poured out into an aluminum dish and grinded after solidification. The melting points have been determined in a Büchi melting point apparatus.

| | | | | Visual Aspect |
|---|---|---|---|---|
| P1 | O 3 | mp. Start | mp End | of solidified |
| [wt %] | [wt %] | [° C.] | [° C.] | product |
| 0% | 100% | 96.6 | 110.7 | amorphous |
| 10% | 90% | 85.8 | 95.6 | amorphous |
| 20% | 80% | 76.6 | 87.2 | amorphous |
| 30% | 70% | 66.4 | 77.6 | amorphous |
| 40% | 60% | 55.2 | 65.5 | amorphous |
| 50% | 50% | 48 | 55.9 | amorphous |
| 60% | 40% | 42.7 | 49.3 | amorphous, |
| | | | | softening |
| 70% | 30% | * | * | amorphous, |
| | | | | softening |
| 80% | 20% | 86.5 | 88.7 | amorphous |
| 90% | 10% | 80.2 | 90 | crystalline |
| 100% | 0% | 90 | 90.5 | crystalline |

* melting points could not determined due to the soft and sticky behavior, mp should be close to room temperature

Also in this example, melting end temperature of the mixtures are found being below the melting point of the crystalline individual products. It has to be mentioned that the melting point of pure crystalline Hostanox O 3 is 167-171° C., but on rapid cooling (as in this example) an amorphous product is obtained with a melting point of about 110° C. as given above).

The melting end points are always below that of the higher melting component and over a wide concentration range of P1 even below 80° C., allowing a liquid dosing of the melt.

### Example 4

For the preparation of the blends, the appropriate weight ratios of the compounds (X) and (Y) are weighted and mixed in a suitable reactor under nitrogen and heated with stirring in an oil bath until a homogeneous melt is obtained. Then the molten blend is poured onto an aluminum dish or porcelain plate to solidify the blend.

For the determination of the percentage of crystalline resp. amorphous phase of these solidified blends, DSC measurements of representative samples of about 5 mg were performed (conditions: start temp. 25° C., end temp. 200° C., heating rate: 10° C.*min⁻¹, nitrogen flow 50 ml/min). During the phase transitions (melting), heat is absorbed by the substance and made visible as endothermic peaks on the corresponding thermograms. The integration of these peaks yields the melting enthalpy ΔH in J/g. In case of showing multiple endothermic peaks, the enthalpies of the individual peaks are summed up for the calculation of the crystalline part.

The crystalline part P_{cryst} in percent of the inventive mixture is calculated by

P_{cryst}=ΔHₘₑₐₛ/ΔH_{calc}=ΔHₘₑₐₛ/(c(X)*ΔHₘₑₐₛ(X)+c(Y)*ΔHₘₑₐₛ(Y))

with
c(X) wt % of (X) in the mixture of (X) and (Y), based on the total weight of the mixture
c(Y) wt % of (Y) in the mixture of (X) and (Y), based on the total weight of the mixture
ΔHₘₑₐₛ measured melting enthalpy of the inventive mixture in J/g
ΔH_{calc} calculated melting enthalpy of the inventive mixture in J/g ΔH_{calc}=c(X)*ΔHₘₑₐₛ(X)+c(Y)* ΔHₘₑₐₛ(Y)
ΔHₘₑₐₛ(X) melting enthalpy of pure (X) in J/g
ΔHₘₑₐₛ(Y) melting enthalpy of pure (Y) in J/g.

As the amorphous and crystalline part sum up to 100 wt %, the following equation holds for the calculation of the amorphous part Pₐₘₒᵣₚₕₒᵤₛ in percent:

Pₐₘₒᵣₚₕₒᵤₛ=100%−P_{cryst}

The table below summarizes the results of the determination of the inventive blends concerning their amorphous resp. crystalline behavior:

| | | | | | Properties | | |
|---|---|---|---|---|---|---|---|
| | Compound (X) | | Compound (Y) | | ΔH_{calc} | ΔHₘₑₐₛ | |
| Ex. | Type | wt % | Type | wt % | [J/g] | [J/g] | Pamorphous |
| 4a | Compound (Ie) | 17 | Compound (IIf) | 83 | 53.4 | 0.0 | 100% |
| 4b | Compound (Ie) | 33 | Compound (IIf) | 66 | 58.1 | 1.1 | 98% |
| 4c | Compound (Ie) | 50 | Compound (IIf) | 50 | 64.2 | 17.1 | 73% |
| 4d | Compound (Ie) | 33 | Compound (IIg) | 66 | 36.8 | 26.3 | 29% |
| 4e | Compound (Ie) | 50 | Compound (IIg) | 50 | 48.0 | 8.3 | 83% |
| 4f | Compound (In) | 33 | Compound (IIe) | 66 | 105.7 | 98.7 | 7% |
| 4g | Compound (In) | 50 | Compound (IIe) | 50 | 99.7 | 94.2 | 6% |
| 4h | Compound (In) | 17 | Compound (IIf) | 83 | 53.0 | 0.0 | 100% |
| 4i | Compound (In) | 33 | Compound (IIf) | 66 | 57.5 | 0.0 | 100% |
| 4j | Compound (In) | 50 | Compound (IIf) | 50 | 63.2 | 23.4 | 63% |
| 4k | Compound (In) | 17 | Compound (IIg) | 83 | 26.2 | 5.3 | 80% |
| 4l | Compound (In) | 33 | Compound (IIg) | 66 | 36.1 | 2.3 | 94% |
| 4m | Compound (In) | 50 | Compound (IIg) | 50 | 47.0 | 0.0 | 100% |

Properties of reference products (pure components):

| | | | | |
|---|---|---|---|---|
| Compound (Ie) | 100 | | | 80.6 |
| Compound (In) | 100 | | | 78.6 |
| | | Compound (IIg) | 100 | 13.7 |
| | | Compound (IIf) | 100 | 47.8 |
| | | Compound (IIe) | 100 | 120.8 |

1. A mixture consisting of
(A) one or more phosphine compounds of formulae (Ib) to (Id) 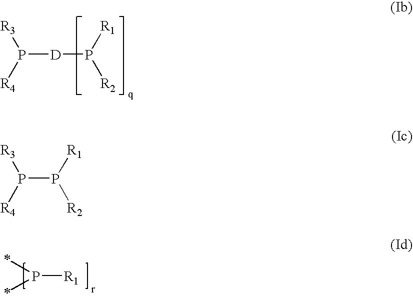
wherein
R₁ to R₄ independently of each other, are C₁₋₂₄alkyl, C₅₋₃₀cycloalkyl, C₁₋₃₀alkylaryl, C₆₋₂₄aryl, C₅₋₂₄heteroaryl, C₆₋₂₄aryl substituted with C₁₋₁₈alkyl or C₅₋₁₂cycloalkyl or C₁₋₁₈alkoxy or C₅₋₂₄heteroaryl substituted with C₁₋₁₈alkyl or C₅₋₁₂cycloalkyl or C₁₋₁₈alkoxy;
D is a (q+1)-valent residue consisting of C₁₋₃₀alkylen, C₁₋₃₀alkyliden, C₅₋₁₂cycloalkylen, C₆₋₂₄arylen, C₆₋₂₄heteroarylen, C₆₋₂₄arylen substituted by C₁₋₁₈alkyl or C₅₋₁₂cycloalkyl or C₁₋₁₈alkoxy or C₆₋₂₄heteroarylen substituted by C₁₋₁₈alkyl or C₅₋₁₂cycloalkyl or C₁₋₁₈alkoxy;
q is from 1 to 5;
r is from 3 to 6,
and wherein the groups P—R₁ in formula (Id) form a phosphacyclic compound, indicated by * at the bonds originating from P,
and
(B) one or more phenolic antioxidant compounds of formula (IIa) 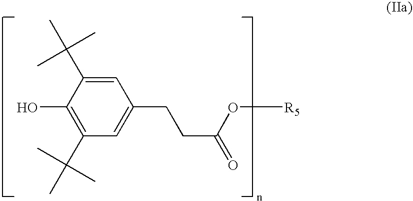
wherein
n is from 1 to 6
R₅ for n=1 is C₁₋₆₀alkyl, C₅₋₃₀cycloalkyl, C₁₋₃₀alkylaryl, C₆₋₂₄aryl, C₅₋₂₄heteroaryl, C₆₋₂₄aryl substituted with C₁₋₁₈alkyl or C₅₋₁₂cycloalkyl or C₁₋₁₈alkoxy or C₅₋₂₄heteroaryl substituted with C₁₋₁₈alkyl or C₅₋₁₂cycloalkyl or C₁₋₁₈alkoxy;
for n>1 is C₁₋₂₄alkylene, C₁₋₂₄alkylene-S—C₁₋₂₄alkylene, C₅₋₃₀cycloalkylene, C₁₋₃₀alkylarylene, C₆₋₂₄arylene, C₅₋₂₄heteroarylene or C₁₋₂₄alkylidene;
or of formula (IIb) 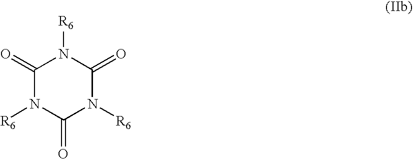
or of formula (IIc) 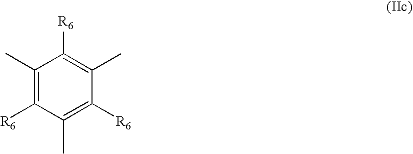
wherein
R₆ is selected from the residues 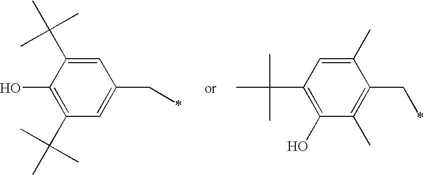
wherein * indicate the connection position to the residue,
or of formula (IId) 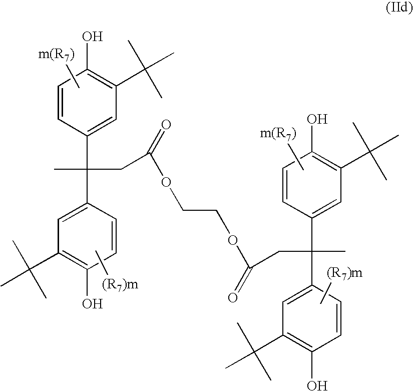
wherein
R₇ is hydrogen, C₁₋₂₄alkyl or C₁₋₂₄alkyloxy, and
m is from 0 to 3.

2. A mixture according to claim 1 consisting of
(A) the one or more phosphine compounds of formulae (Ib) to (Id) wherein
R₁ to R₄ independently of each other, are C₆₋₂₄alkyl, C₆₋₁₈cycloalkyl, C₇₋₂₅alkylaryl, C₆₋₁₈aryl, C₅₋₁₈heteroaryl, C₆₋₁₈aryl substituted with C₁₋₁₂alkyl or C₆₋₈cycloalkyl or C₁₋₁₂alkoxy-, or C₅₋₁₈heteroaryl substituted with C₁₋₁₂alkyl or C₆₋₈cycloalkyl or C₁₋₁₂alkoxy;
D is a (q+1)-valent residue consisting of C₁₋₂₄alkylen, C₁₋₂₄alkyliden, C₅₋₈cycloalkylen, C₆₋₁₈arylen, C₆₋₁₈arylen substituted by C₁₋₁₈alkyl or C₆₋₈cycloalkyl or C₁₋₁₈alkoxy, C₆₋₁₈heteroarylen or C₆₋₁₈heteroarylen substituted by C₁₋₁₈alkyl or C₆₋₈cycloalkyl or C₁₋₁₈alkoxy;
and
(B) the one or more phenolic antioxidant compounds of formulae (IIa) to (IId) wherein
n is from 1 to 4,
R₅ for n=1 is C₁₋₁₈alkyl, C₅₋₁₈cycloalkyl, C₁₋₂₄alkylaryl, C₆₋₁₈aryl, C₅₋₁₈heteroaryl, C₆₋₁₈aryl substituted with C₁₋₁₂alkyl or C₆₋₈cycloalkyl or C₁₋₁₂alkoxy or C₅₋₁₈heteroaryl substituted with C₁₋₁₂alkyl or C₆₋₈cycloalkyl or C₁₋₁₂alkoxy,
for n>1 is C₁₋₁₈alkylene, C₁₋₁₈alkylene-S—C₁₋₁₈alkylene, C₆₋₈-cycloalkylene, C₁₋₁₈alkylarylene, C₆₋₁₈arylene, C₅₋₁₈heteroarylene or C₁₋₁₈alkylidene;
R₆ is selected from the residues 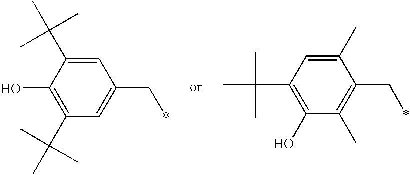
wherein * indicate the connection position to the residue,
R₇ is hydrogen, C₁₋₁₈alkyl or C₁₋₁₈alkyloxy, and
m is 0 to 2.

3. A mixture according to claim 1 consisting of
(A) the one or more phosphine compound of formulae (Ib) to (Id) wherein
R₁ to R₄ independently of each other, are C₆₋₁₈alkyl, C₆₋₁₂cycloalkyl, C₇₋₁₈alkylaryl, C₆₋₁₂aryl, C₅₋₁₂heteroaryl, C₆₋₁₂aryl substituted with C₁₋₈alkyl or cyclohexyl or C₁₋₈alkoxy or C₅₋₁₂heteroaryl substituted with C₁₋₈alkyl or cyclohexyl or C₁₋₈alkoxy;
D is a (q+1)-valent residue consisting of C₁₋₁₈alkylen, C₁₋₁₈alkyliden, C₅₋₆cycloalkylen, C₆₋₁₂arylen, C₆₋₁₂arylen substituted by C₁₋₁₂alkyl or C₅₋₆cycloalkyl or C₁₋₁₂alkoxy, C₆₋₁₂heteroarylen or C₆₋₁₂heteroarylen substituted by C₁₋₁₂alkyl or C₅₋₆cycloalkyl or C₁₋₁₂alkoxy;
and
(B) the one or more phenolic antioxidant compounds of formulae (IIa) to (IId) wherein
n is 1 to 4,
R₅ for n=1 is C₁₋₁₂alkyl, C₆₋₈cycloalkyl, C₁₋₁₂alkylaryl, C₆₋₁₂aryl, C₅₋₁₂heteroaryl, C₆₋₁₂aryl substituted with C₁₋₈alkyl or cyclohexyl or C₁₋₈alkoxy-, or C₅₋₁₂heteroaryl substituted with C₁₋₈alkyl or cyclohexyl or C₁₋₈alkoxy,
for n>1 is C₁₋₁₂alkylene, C₁₋₁₂alkylene-S—C₁₋₁₂alkylene, cyclohexylene, C₁₋₁₂alkylarylene, C₆₋₁₂arylene, C₁₋₁₂heteroarylene or C₁₋₁₂alkylidene;
R₆ is selected from the residues 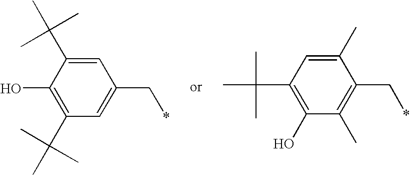
wherein * indicate the connection position to the residue,
R₇ is hydrogen, C₁₋₁₂alkyl or C₁₋₁₂alkyloxy, and
m is 0 or 1.

4. A mixture according to claim 1, wherein independently from each other the alkyl, alkylen, alkyliden, cycloalkyl or cycloalkylen moieties inside the chain or in the ring contain N, O, P, or S.

5. A mixture according to claim 3 consisting of
(A) the one or more phosphine compounds of the following formulae (Ih) to (Ip) 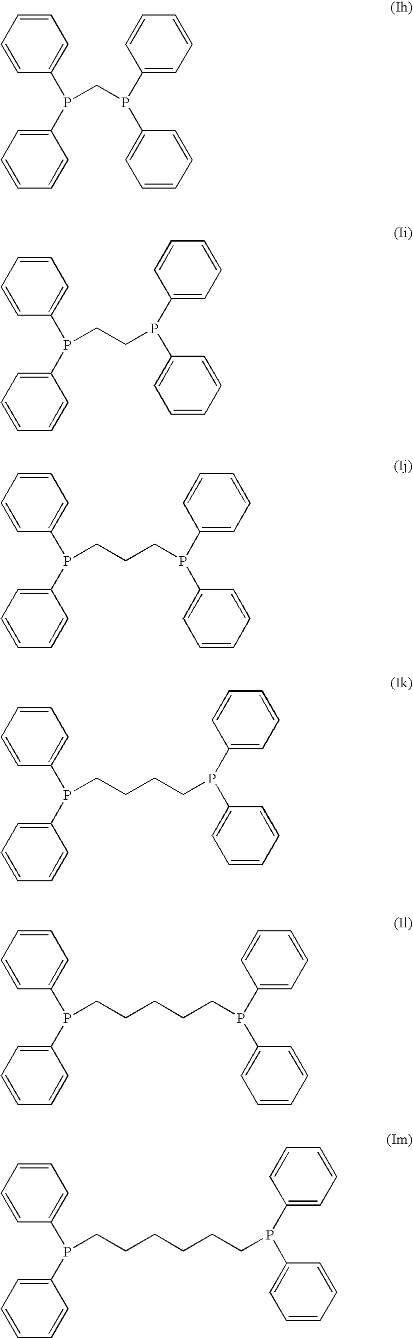 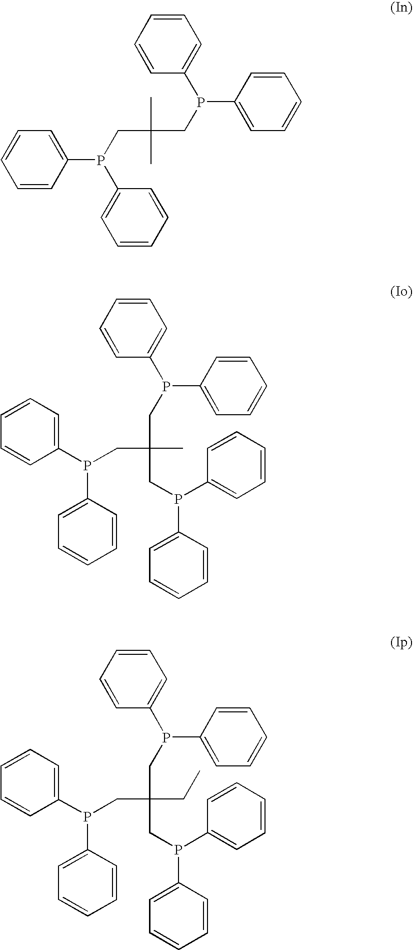
and
(B) the one or more phenolic antioxidant compounds of the following formulae (IIe) to (IIk)

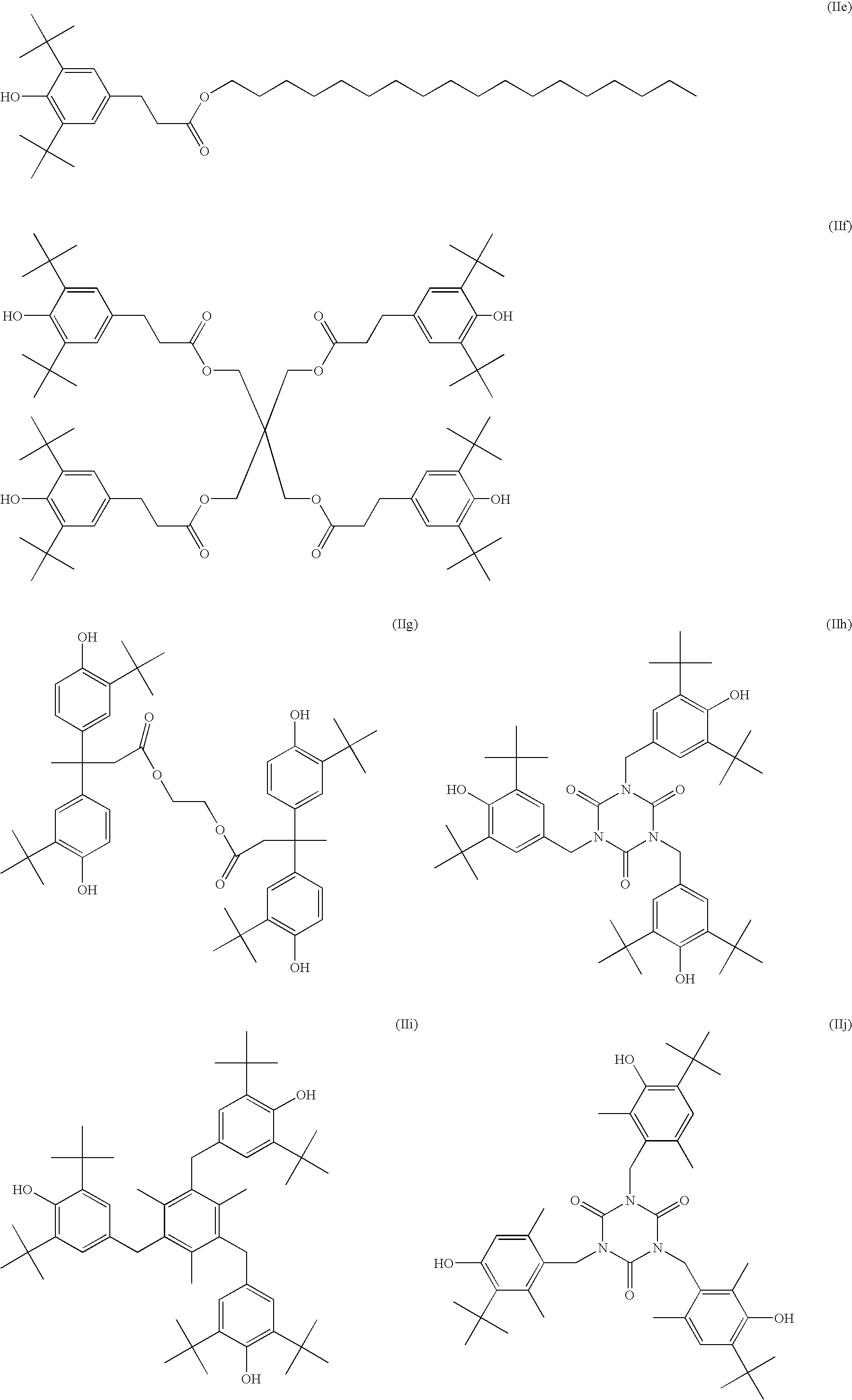

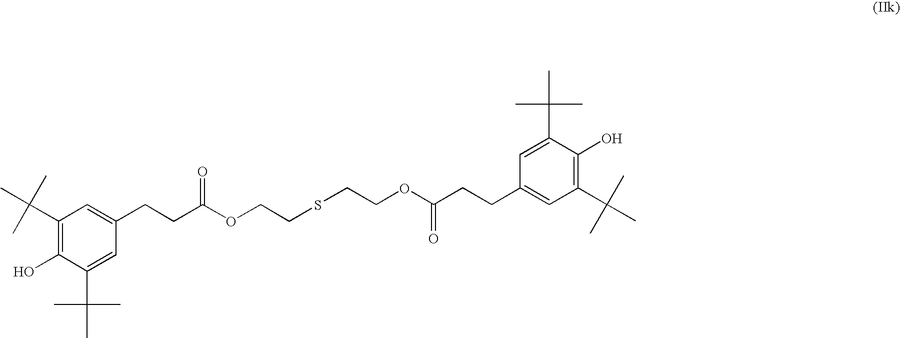

6. A mixture according to claim 5 consisting of
(A) the one or more phosphine compounds of the formula Ih, Ii, Ij, In, Io or Ip and
(B) the one or more phenolic antioxidant compounds of the formula IIe, IIf, IIg, IIh, IIi or IIj.

7. A mixture according to claim 1 wherein component (A) is 1,3-Bis(diphenylphosphino)-2,2-dimethyl-propane of formula (In) and component (B) is octadecyl-(4-hydroxy-3,5-di-tert.-butyl-phenyl)hydrocinnamate of formula (IIe).

8. A mixture according to claim 1, containing from 1 to 99% by weight of the one or more phosphine compounds (A) and from 99 to 1% by weight of the one or more phenolic antioxidants (B), based on the weight of the total mixture.

9. A mixture according to claim 1, wherein the components (A) and (B) are crystalline.

10. A mixture according to claim 1, wherein the mixture comprises amorphous material of components (A) and (B).

11. A mixture according to claim 8 wherein the mixture forms amorphous solids on cooling from a liquid state, and contains from 1 to 70% by weight of the one or more phosphine compounds (A) and from 99 to 30% by weight of the on or more phenolic antioxidants (B), based on the weight of the total mixture.

12. A mixture according to claim 8, wherein at least 25% by weight of the mixture, based on the total weight of the mixture, is an amorphous mixture of the components (A) and (B).

13. A mixture according to claim 10, wherein component (A) is of formula (In).

14. A process for preparing a mixture according to
consisting of one or more components (A) and one or more components (C) and one or more components (B);
with component (A) being one or more phosphine compounds of formulae (Ib) to (Id) 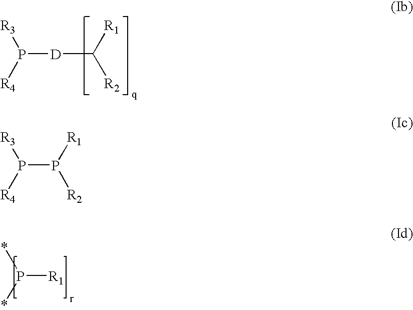
wherein
R₁ to R₄ independently of each other, are C₁₋₂₄alkyl, C₅₋₃₀cycloalkyl, C₁₋₃₀alkylaryl, C₆₋₂₄aryl, C₅₋₂₄heteroaryl, C₆₋₂₄aryl substituted with C₁₋₁₈alkyl or C₅₋₁₂cycloalkyl or C₁₋₁₈alkoxy, or C₅₋₂₄heteroaryl substituted with C₁₋₁₈alkyl or C₅₋₁₂cycloalkyl or C₁₋₁₈alkoxy;
D is a (q+1)-valent residue consisting of C₁₋₃₀alkylen, C₁₋₃₀alkyliden, C₅₋₁₂cycloalkylen. C₆₋₂₄arylen, C₆₋₂₄heteroarylen, C₆₋₂₄arylen substituted by C₁₋₁₈alkyl or C₅₋₁₂cycloalkyl or C₁₋₁₈alkoxy, or C₆₋₂₄heteroarylen substituted by C₁₋₁₈alkyl or C₅₋₁₂cycloalkyl or C₁₋₁₈alkoxy;
q is from 1 to 5;
r is from 3 to 6,
and wherein the groups P—R₁ in formula (Id) form a phosphacyclic compound, indicated by * at the bonds originating from P,
with component (B) being one or more phenolic antioxidant compounds of formula (IIa) 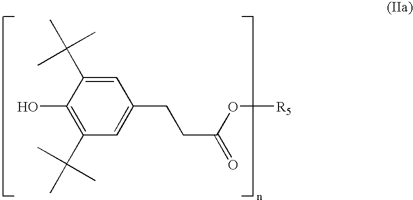
wherein
n is from 1 to 6
R₅ for n=1 is C₁₋₆₀alkyl, C₅₋₃₀cycloalkyl, C₁₋₃₀alkylaryl, C₆₋₂₄aryl, C₅₋₂₄heteroaryl, C₆₋₂₄aryl substituted with C₁₋₁₈alkyl or C₅₋₁₂cycloalkyl or C₁₋₁₈alkoxy, or C₅₋₂₄heteroaryl substituted with C₁₋₁₈alkyl or C₅₋₁₂cycloalkyl or C₁₋₁₈alkoxy;
for n>1 is C₁₋₂₄alkylene, C₁₋₂₄alkylene-S—C₁₋₂₄alkylene, C₅₋₃₀cycloalkylene, C₁₋₃₀alkylarylene, C₆₋₂₄arylene, C₅₋₂₄heteroarylene or C₁₋₂₄alkylidene;
or of formula (IIb) 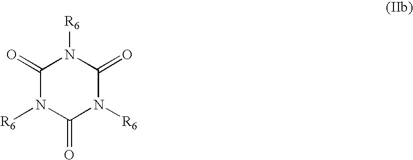
or of formula (IIc) 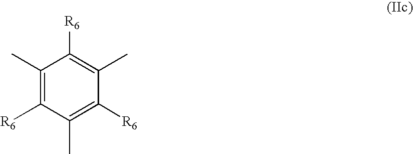
wherein
R₆ is selected from the residues 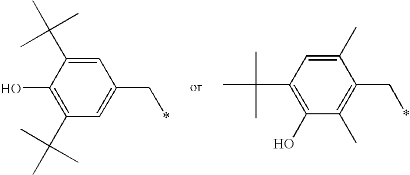
wherein * indicate the connection position to the residue,
or of formula (IId) 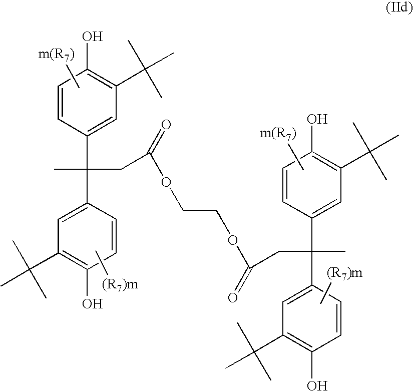
wherein
R₇ is hydrogen, C₁₋₂₄alkyl, or C₁₋₂₄alkyloxy, and
m is from 0 to 3.
with the component (C) being a phosphine of the formula (Ia) 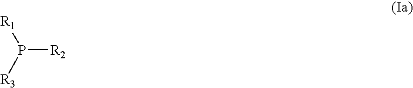
wherein
R₁ to R₃ independently of each other, are C₁₋₂₄alkyl, C₅₋₃₀cycloalkyl, C₁₋₃₀alkylaryl, C₆₋₂₄aryl, C₅₋₂₄heteroaryl, C₆₋₂₄aryl substituted with C₁₋₁₈alkyl or C₅₋₁₂cycloalkyl or C₁₋₁₈alkoxy or C₅₋₂₄heteroaryl substituted with C₁₋₁₈alkyl or C₅₋₁₂cycloalkyl or C₁₋₁₈alkoxy;
comprising the step of cooling a liquid mixture comprising one or more components (A) or (C) and one or more components (B) below the solidification point.

15. A process for preparing a mixture according to claim 1, comprising the step of mixing component (A) with component (B).

16. A process according to claim 15, wherein the mixing step further comprises mixing component(A) and component (B) into a homogenous blend and heating the blend above the melting temperature of the higher melting component of component (A) or (B) or by mixing individual melts or solutions of component (A) and component (B), and evaporating the solvent in the case of solutions, and forming the blend during or after cooling down to a solid.

17. A stabilized polymer comprising mixture according to claim 1.

18. (canceled)

19. A process for making a stabilized polymer comprising the step of adding the mixture in liquid form to the polymer during processing.

20. A process for preparing—a mixture
consisting of one or more components (C) and of one or more components (B), with component (B) one or more phenolic antioxidant compounds of formula (IIa) 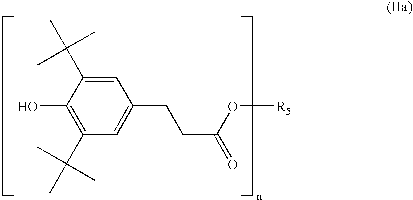
wherein
n is from 1 to 6
R₅ for n=1 is C₁₋₆₀alkyl, C₅₋₃₀cycloalkyl, C₁₋₃₀alkylaryl, C₆₋₂₄aryl, C₅₋₂₄heteroaryl, C₆₋₂₄aryl substituted with C₁₋₁₈alkyl or C₅₋₁₂cycloalkyl or C₁₋₁₈alkoxy or C₅₋₂₄heteroaryl substituted with C₁₋₁₈alkyl or C₅₋₁₂cycloalkyl or C₁₋₁₈alkoxy;
for n>1 is C₁₋₂₄alkylene, C₁₋₂₄alkylene-S—C₁₋₂₄alkylene, C₅₋₃₀cycloalkylene, C₁₋₃₀alkylarylene, C₆₋₂₄arylene, C₅₋₂₄heteroarylene or C₁₋₂₄alkylidene;
or of formula (IIb) 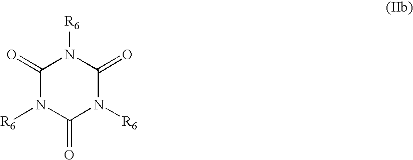
or of formula (IIc) 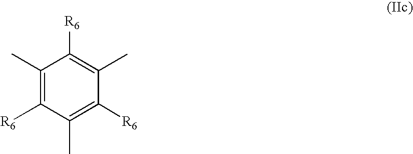
wherein
R₆ is selected from the residues 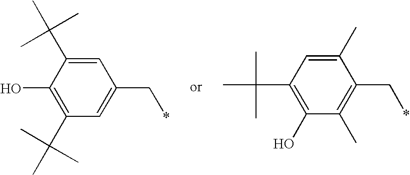
wherein * indicate the connection position to the residue,
or of formula (IId) 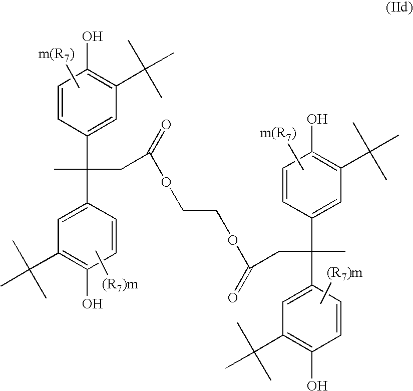
wherein
R₇ is hydrogen, C₁₋₂₄alkyl or C₁₋₂₄alkyloxy, and
m is from 0 to 3.
comprising the step of cooling a liquid mixture comprising one or more components (C) and one or more components (B) below the solidification point.

21. A mixture made in accordance with the process of claim 14.

22. A mixture made in accordance with the process of claim 20.

23. A stabilized polymer comprising a mixture according to claim 21.

24. A stabilized polymer comprising a mixture according to claim 22.

25. A process for making a stabilized polymer according to claim 23 comprising the step of adding the mixture in liquid form to the polymer during processing.

26. A process for making a stabilized polymer according to claim 24, comprising the step of adding the mixture in liquid form to the polymer during processing.
